(19) United States
(12) Patent Application Publication
(10) Pub. No.: US 2026/0292511 A1
(43) Pub. Date: Sep. 24, 2026

(54) METHOD AND SYSTEM FOR MONITORING CYBERSECURITY IN AIRCRAFT SYSTEM

(71) Applicant: Honeywell International Inc., Charlotte, NC (US)

(72) Inventor: Saravanakumar Gurusamy, Bangalore (IN)

(21) Appl. No.: 19/250,090

(22) Filed: Jun. 26, 2025

(30) Foreign Application Priority Data
Mar. 18, 2025 (IN) 202511024111

(51) Int. Cl. H04W 12/122; H04W 12/06

(52) U.S. Cl. CPC H04W 12/122; H04W 12/068

(57) ABSTRACT

The present disclosure provides a system for monitoring cybersecurity in an aircraft system, the aircraft system comprises one or more processors, a memory, and one or more programs store in the memory. The aircraft system is configured to monitor one or more parameters associated with various aircraft modules, including data storage size, data exchanges, and process execution activities. The aircraft system analyzes the parameters to determine one or more vulnerabilities, such as abnormal increases in storage size of data files, data access requests, data exchanges, and unplanned process executions. The aircraft system identifies at least one vulnerability, including an unauthorized process execution, unauthorized data access attempts, and an abrupt increase in data storage, which could indicate security breaches. Upon detecting any vulnerability, the aircraft system generates an alert to notify the aircraft crew to perform mitigation strategies.

### FIELD OF INVENTION

The present disclosure generally relates to a method for monitoring cybersecurity. In particular, the present disclosure provides a method and system for monitoring cybersecurity in an aircraft system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Avionics systems form the backbone of modern aircraft, integrating essential functionalities that range from navigation and communication to flight control and monitoring. These modern electronic systems enhance operational efficiency, improve safety, and enable advanced capabilities such as autopilot, weather tracking, and real-time data analysis. As the aviation industry continues to evolve, the integration of digital technologies and connectivity has become paramount in optimizing performance and experience of the user.

However, with the advancements, the avionics system is more prone to cybersecurity threats. As avionics systems become more interconnected and reliant on data-sharing and cloud services, they are increasingly vulnerable to cyberattacks. In order to address the cybersecurity issues in the context of avionics systems, the Radio Technical Commission for Aeronautics (RTCA) has provided the DO-326/DO-356A documents that provide guidelines and standards for addressing cybersecurity issues in the avionics systems. These documents are part of the broader set of guidelines related to the safety and security of airborne and ground-based systems.

FIG. 1 illustrates an integrated avionic security framework 100 of an avionics system. The integrated avionics security framework 100 depicts a ‘V’ process developed for a security architecture for the avionics system. The integrated avionic security framework 100 defines the security requirements that align with the operational and safety needs. The integrated avionic security framework 100 defines the relationship between various stages of development, from requirements definition to design, implementation, verification, and validation (VV&A). For example, as can be seen in FIG. 1, the left side and the right side of ‘V’ define the system requirements definition and detail the processes of integration, testing requirements, and the like. Further, the middle of the ‘V’ involves various levels of verification like aircraft verification and the system verification.

FIG. 2 illustrates a security risk assessment process associated with an avionics system. FIG. 2 depicts the security risk assessment process 200 of evaluating potential security risks associated with aviation systems as described in the RTCA documents. The security risk assessment process 200 describes a structured approach to identify, analyze, and mitigate security vulnerabilities within the avionics system. The security risk assessment process 200 defines the scope of risk assessment for the architecture under consideration. For example, section 201 defines a process of threat condition identification and evaluation. Further section 203 defines a process of identifying an impact of the threat, and threat scenarios. Likewise, section 205 defines the process of security measures characterization. Further, the section 207 defines the process of level of threat evaluation. Thus, security risk assessment process 200 describes the various security measures that need to be developed are identified, and implemented at the aircraft and system levels.

FIG. 3 illustrates security measures implemented in the avionics system as per the described standards. FIG. 3 depicts the security measures 300 taken during an attack on the avionics system. When the attack occurs, at levels 301, 303, and 305, the avionics system takes procedural security measures such as deterrent measures, preventive measures, detective measures, corrective measures, and recovery measures. Further, when the attack occurs, at levels 301, 303, and 305, the avionics system takes technical security measures such as deterrent measures, preventive measures, detective measures, and recovery measures.

Though, the RTCA documents offer a foundational framework for initiating the cybersecurity process, however, they remain at a high level, with specific security measures (such as detection measures, deterrence measures, and recovery measures) delegated to connected module suppliers. Additionally, the RTCA documents provide no details for pilot action or maintenance actions. Further, the industry standards, including the DO-326/DO-356A documents, mandate the SAL3 requirements in the avionics systems. Thus, currently, there is a need to comply with the SAL3 requirements for the aircraft. However, this necessitates expensive hardware and software updates to data loader units, as well as the implementation of enhanced software development practices. For example, to upgrade the software development level (IDAL) of software components from DAL E to DAL A to align with the SAL3 requirements, will require costly hardware and software upgrades to the data loader units. In addition, there is an alarming increase in cyberattacks across the aviation industry, affecting both avionics and non-avionics systems. For example, targeted enterprise and operational platforms, such as ticketing and boarding processes are already at the potential risk of cyber threats which further may escalate to the aircraft and avionics domains.

Generally, the aircraft continuously exchanges vast amounts of data with ground stations, onboard modules, and external networks. This data includes sensitive flight information, operational logs, and passenger records, making the aircraft susceptible for cyberattacks. Attackers gather this type of data to get valuable insights into the aircraft. Thus, unauthorized access, data leaks, and malicious cyber activities can compromise flight safety, disrupt operations, and lead to significant security risks. The present invention discloses a method that ensures robust security measures for aircraft operations by monitoring system parameters, detecting unauthorized data access, and identifying abnormal data storage behaviors. The disclosed method enhances the cybersecurity framework in aviation by providing real-time alerts to flight crews for performing mitigation strategies to prevent data breaches, unauthorized modifications, and malicious cyber activities.

The conventional aviation cybersecurity systems lack real-time cybersecurity monitoring to detect and prevent potential cyber threats. Cyber attackers usually inject vulnerabilities in data exchange processes, unauthorized file modifications, or unplanned system executions to infiltrate aircraft systems. For instance, an attacker might attempt to install malware by disguising it as a legitimate software update or exfiltrate critical data by gradually increasing storage file sizes to avoid detection. These anomalies may go undetected until significant security breaches occur, compromising flight operations and data integrity. Thus, there is a need to develop security measures deployed within the aircraft system to detect unauthorized access and data exfiltration attempts.

Thus, there is a need to provide a method for monitoring cybersecurity in the aircraft system.

Through applied effort, ingenuity, and innovation, the inventors have solved and proposed the above problem(s) by developing the solutions embodied in the present disclosure, the details of which are described further herein.

### SUMMARY OF THE INVENTION

In general, embodiments of the present disclosure herein provide a solution for monitoring cybersecurity in an aircraft system. Other implementations will be or will become, apparent to one with skill in the art upon examination of the following figures and detailed description. It is intended that all such additional implementations be included within this description within the scope of the disclosure.

According to an embodiment of the present disclosure, a method for monitoring cybersecurity in an aircraft is disclosed. The method includes monitoring one or more parameters associated with one or more modules deployed in the aircraft system. The one or more parameters include at least one of a storage size of data files, data exchanges, and a process execution. The method further includes performing an analysis of the one or more parameters. The method further includes determining an increase in the storage size, for each of the data files, beyond a threshold value. The method further includes determining a data access request from an unknown source. The method further includes determining unauthorized data exchanges with the unknown source. The method further includes determining an unplanned process execution. The method further includes identifying at least one vulnerability based on the analysis of the one or more parameters. The at least one vulnerability includes one or more of an unauthorized process execution, an unauthorized data access request, or an abrupt increase in the storage size of the data files. The method further includes notifying an alert to an aircraft crew, indicating the at least one vulnerability.

According to an embodiment of the present disclosure, a system for monitoring cybersecurity in an aircraft system is disclosed. The system comprises one or more processors, a memory, and one or more programs stored in the memory. The one or more programs when executed by the one or more processors cause the one or more processors to monitor one or more parameters associated with one or more modules deployed in the aircraft system. The one or more parameters include at least one of a storage size of data files, data exchanges, and a process execution. The one or more processors are configured to perform an analysis of the one or more parameters. The one or more processors are further configured to determine an increase in the storage size, for each of the data files, beyond a threshold value. The one or more processors are further configured to determine a data access request from an unknown source. The one or more processors are further configured to determine unauthorized data exchanges with the unknown source. The one or more processors are further configured to determine an unplanned process execution. The one or more processors are further configured to identify at least one vulnerability based on the analysis of the one or more parameters. The at least one vulnerability includes one or more of an unauthorized process execution, an unauthorized data access request, or an abrupt increase in the storage size of the data files. The one or more processors are further configured to notify an alert to an aircraft crew, indicating the at least one vulnerability.

According to yet another embodiment, the present disclosure discloses a non-transitory computer-readable storage medium storing program instructions for cybersecurity monitoring in an aircraft system, the program instructions, when executed, perform the steps of monitoring one or more parameters associated with one or more modules deployed in the aircraft system. The one or more parameters include at least one of a storage size of data files, data exchanges, and a process execution. The non-transitory computer-readable storage medium comprises steps of performing an analysis of the one or more parameters. The non-transitory computer-readable storage medium further comprises steps of determining an increase in the storage size, for each of the data files, beyond a threshold value. The non-transitory computer-readable storage medium further comprises steps of determining a data access request from an unknown source. The non-transitory computer-readable storage medium further comprises steps of determining unauthorized data exchanges with the unknown source. The non-transitory computer-readable storage medium further comprises steps of determining an unplanned process execution. The non-transitory computer-readable storage medium further comprises steps of identifying at least one vulnerability based on the analysis of the one or more parameters. The at least one vulnerability includes one or more of an unauthorized process execution, an unauthorized data access request, or an abrupt increase in the storage size of the data files. The non-transitory computer-readable storage medium further comprises steps of notifying an alert to an aircraft crew, indicating the at least one vulnerability.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### DESCRIPTION OF THE DRAWINGS

Having thus described the embodiments of the disclosure in general terms, reference now will be made to the accompanying drawings, which are not necessarily drawn to scale, and wherein:

FIG. 1 illustrates an integrated avionic security framework of an avionics system;

FIG. 2 illustrates a security risk assessment process associated with the avionics system;

FIG. 3 illustrates security measures implemented in the avionics system as per the described standards;

FIG. 4 illustrates an example environment for monitoring cybersecurity in an aviation system, according to an embodiment of the present disclosure;

FIG. 5 illustrates an example of an avionic cabinet in the aircraft system for monitoring cybersecurity in an aircraft, according to an embodiment of the present disclosure;

FIG. 6 illustrates a block diagram of modules for monitoring cybersecurity in the aircraft system, according to an embodiment of the present disclosure;

FIG. 7 illustrates a flow chart for a method for an unauthorized data storage in the aircraft system, according to an embodiment of the present disclosure;

FIG. 8 illustrates a flow chart for a method for an unauthorized data exchange in the aircraft system, according to an embodiment of the present disclosure;

FIG. 9 illustrates a flow chart for a method for an unauthorized data access request in the aircraft system, according to an embodiment of the present disclosure;

FIG. 10 illustrates an exemplary user interface (UI) for notifying an alert to a pilot or crew, according to an embodiment of the present disclosure;

FIG. 11 illustrates a flow chart for a method for monitoring cybersecurity in the aircraft system, according to an embodiment of the present disclosure; and

FIG. 12 illustrates a general block diagram of the aircraft system, according to an embodiment of the present disclosure.

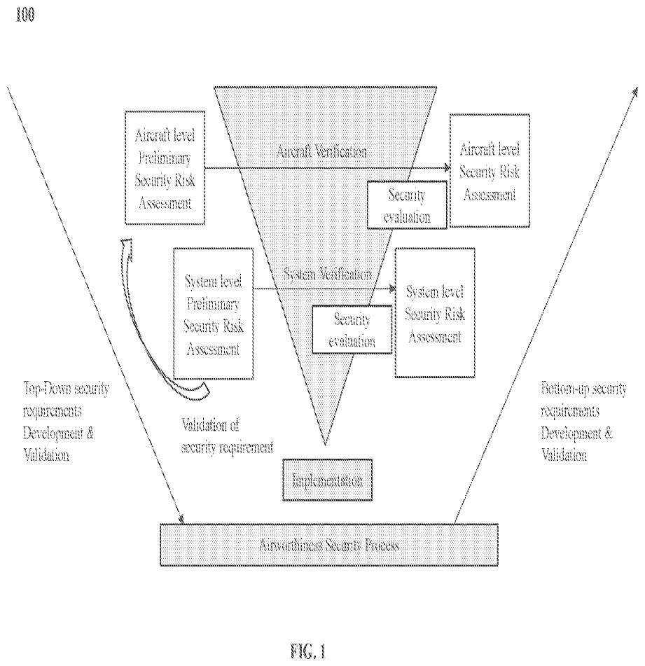

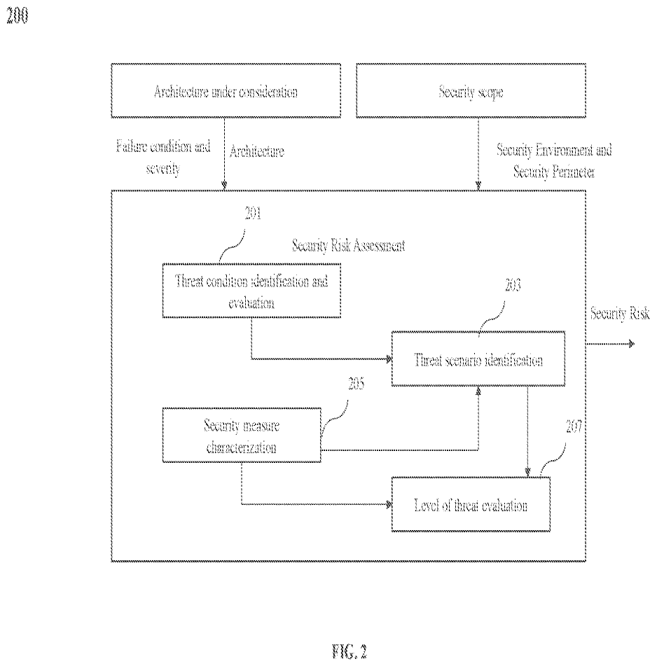

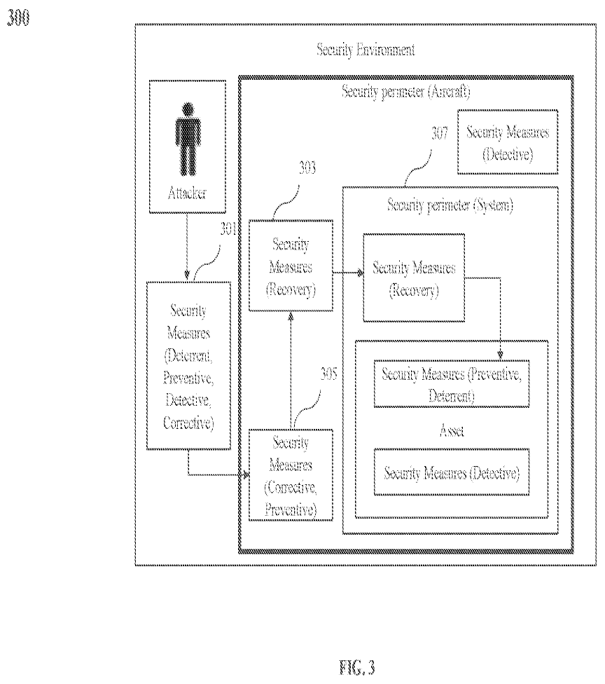

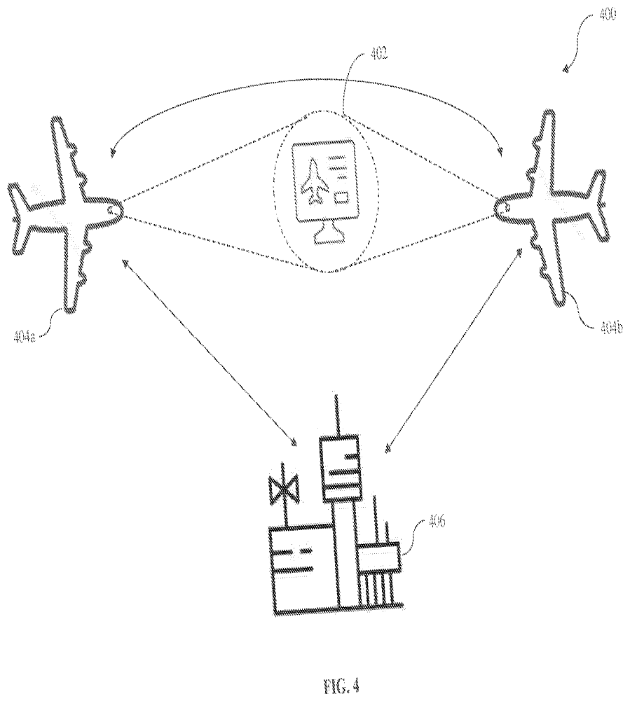

### DESCRIPTION OF THE INVENTION

The description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present invention may be practiced without these specific details. Further, the reference numerals for similar components, modules, units, and operation steps have been kept same for the ease of understanding.

Some embodiments of the present disclosure now will be described with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements.

The present disclosure provides a method for monitoring and mitigating cybersecurity threats in an aviation system by continuously analyzing data exchanges, storage activities, and process executions across aircraft and ground stations. In an embodiment, the disclosed method detects potential vulnerabilities such as unauthorized access requests, abnormal data transmissions, and unplanned process executions by monitoring various system parameters. The method utilizes predefined security thresholds and anomaly detection mechanisms to identify deviations from normal operational behavior. In a non-limiting example, the cybersecurity monitoring system detects an abnormal increase in storage size within an aircraft's onboard system, potentially indicating unauthorized data accumulation or exfiltration attempts. The disclosed methodology ensures that any unauthorized data access requests from an unknown ground entity are identified and authenticated before granting access. If the request fails authentication, the system denies access and generates an alert for the aviation security team. Additionally, any unexpected process executions are validated against a predefined schedule, and unauthorized processes are promptly aborted to prevent potential cyber threats. The disclosed method enhances aviation cybersecurity by preventing data leaks, unauthorized access, and malicious software executions, thereby safeguarding critical flight operations and communication networks. The forthcoming paragraphs will explain the methodology in detail.

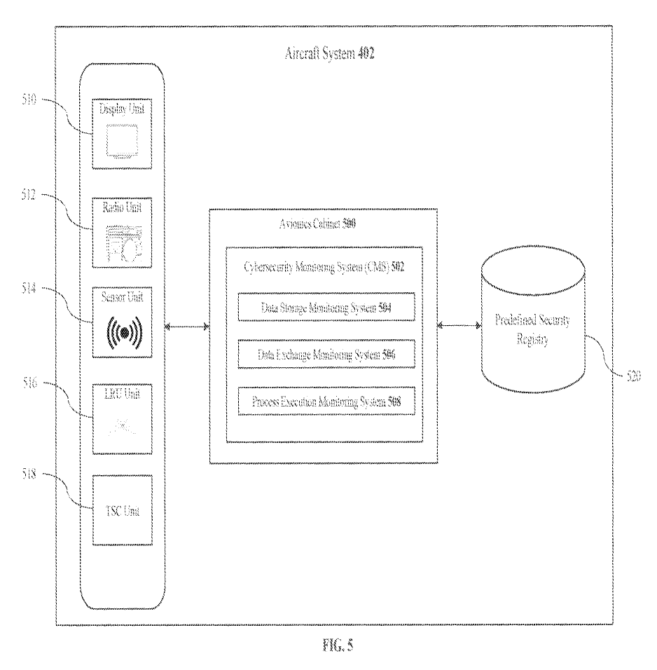

FIG. 4 illustrates an example environment 400 for monitoring cybersecurity in an aviation system, according to an embodiment of the present disclosure. According to an exemplary embodiment, the environment 400 for monitoring cybersecurity may include an aircraft 404a, an aircraft 404b, and a ground station 406 interconnected via a secure communication network. The aircraft 404a and the aircraft 404b are equipped with an aircraft system 402 for monitoring cybersecurity in the aircraft 404a and the aircraft 404b. The aircraft system 402 may be configured to continuously track critical parameters such as data storage, data exchanges, and process executions. The aircraft 404a and 404b can be collectively labeled aircraft 404 throughout the disclosure. In an exemplary embodiment, the aircraft system 402 of the aircraft 404 includes avionics control units, network security modules, intrusion detection systems (IDS), data logging units, and encryption modules to ensure secure data transmission.

In an embodiment, the ground station 406 is integrated with a centralized cybersecurity management system that processes data received from the aircraft 404 in real time. The ground station 406 may include cloud-based systems, security operation centers (SOC), and data analytics platforms for monitoring and detecting cybersecurity threats. The monitoring system continuously analyzes incoming data for anomalies, such as unauthorized access attempts, unexpected data transfers, or abnormal storage growth. The ground station 406 may provide a secured interface for authorized entity to review alerts, respond to threats, and implement mitigation protocols.

According to some embodiments, the communication between the aircraft 404 and the ground station 406 is secured using encryption techniques, authentication protocols, and intrusion detection mechanisms. The data exchanges occur through satellite links, secured radio frequencies, or dedicated aviation networks, ensuring that only authorized entities have access to critical aviation data. By deploying such a cybersecurity monitoring system, aviation operators can enhance real-time threat detection, prevent unauthorized data access, and improve the overall security posture of aircraft communication networks.

FIG. 5 illustrates an example of an avionic cabinet in the aircraft system 402 for monitoring cybersecurity in the aircraft 404, according to an embodiment of the present disclosure. In an embodiment, the aircraft system 402 includes an avionics cabinet 500 to house, protect, and manage various avionics systems essential for communication, navigation, surveillance, and aircraft control. In an embodiment, the avionic cabinet 500 may include a Cybersecurity Monitoring System (CMS) 502 that may be configured to monitor the data storage, the data exchanges, and the process executions in the aircraft 404. In an embodiment, the CMS 502 may include a data storage monitoring system 504, a data exchange monitoring system 506, and a process execution monitoring system 508.

According to an embodiment, the CMS 502 may be configured to monitor the data exchange between the aircraft 404 and the ground station 406 via the data exchange monitoring system 506, the data storage of data files in the aircraft 404 via data storage monitoring system 504, and the process execution via the process execution monitoring system 508. Further, the CMS 502 may validate the data storage of the data files, the process execution of the software, and the data exchange between the aircraft 404 and the ground station 406 using a registry files store in a predefined security registry 520. The predefined security registry 520 may be corresponds to a centralized database that maintains records of authorized entities, their authentication credentials, and access permissions for specific data and system resources. In a non-limiting example, the predefined security registry 520 includes details such as user identities, cryptographic keys, digital certificates, role-based access controls (RBAC), and predefined permissions that dictate what data or system functions each entity can access. In an embodiment, the predefined security registry 520 is continuously updated to reflect changes in personnel, revoked credentials, and emerging cyber threats, ensuring robust protection against unauthorized access, data breaches, and malicious intrusions. Further, the predefined security registry 520 supports multi-factor authentication (MFA) and real-time monitoring to enhance overall security.

For example, when a data access request or process execution is initiated, the system cross-references the requestor's credentials with the predefined security registry 520 to validate authorization. If the entity is recognized and has the necessary permissions, the request is approved, ensuring seamless yet secure operations. However, if the request originates from an unregistered or unauthorized source, it is flagged as a potential security threat, triggering alerts, and blocking access.

Upon validation of the data storage of the data files, the process execution of the software, and the data exchange between the aircraft 404 and the ground station 406. Accordingly, the CMS 502 may detect at least one of an unauthorized process execution, an unauthorized data storage, and an unauthorized data exchange as the threat, then the CMS 502 may provide the information related to the detected threat to a pilot and crew via notification.

Further, the aircraft system 402 may perform one or more preventive actions in response to the detected threat based on the input from the pilot and the crew. For example, in case the threat is detected in the CMS 502, the aircraft system 402 may isolate/terminate at least one of a vulnerable file, vulnerable data, a vulnerable network, and a vulnerable process. Further, the aircraft system 402 may cross-validate content of the registry files with the ground station 406.

According to an embodiment, the avionic cabinet 500 is further operatively coupled with various sources like a display unit 510, a radio unit 512, a sensor unit 514, a Line replaceable unit (LRU) 516, and a tactical support computer (TSC) unit 518. In an exemplary embodiment, the display unit 510 acts as the primary user interface for the pilot and the crew, providing real-time alerts, cybersecurity warnings, and system status reports. For example, if the unauthorized data exchange is detected between the aircraft and an unknown ground station, the display unit 510 alerts the pilot and suggests mitigation strategies such as blocking communication with an unverified source.

Accordingly, the radio unit 512 is responsible for secure voice and data communication between the aircraft 404, ground stations, and other aircraft. It is continuously monitored to detect the unauthorized data access attempts, unusual transmission patterns, or signal jamming. For example, if an unverified command request is received from an unauthorized entity attempting to interfere with aircraft controls, the aircraft system 402 flags and blocks the request.

Further, the sensor unit 514 may be configured to collect and verify real-time data from various aircraft subsystems, including engine health, fuel levels, and navigation systems, ensuring that sensor data remains unaltered and free from cyber threats. For example, if an attacker attempts to manipulate altitude readings to mislead the pilot or ground control, the aircraft system 402 cross-checks the readings across multiple sensors and generates the alert.

Accordingly, the LRU 516 may include modular avionics components such as flight control systems and navigation modules, with cybersecurity mechanisms to monitor software updates, firmware integrity, and unauthorized access attempts. For example, if an attacker tries to install unauthorized firmware on a navigation LRU, the aircraft system 402 detects an anomaly through checksum verification and prevents the update.

Further, the TSC unit 518 is configured for mission-specific calculations and strategic operations, particularly in a military aircraft. The avionic cabinet 500 safeguards the TSC unit 518 from unauthorized command executions, cyber intrusions, or data breaches. For example, if a malicious actor attempts to inject unauthorized scripts to manipulate mission operations, the aircraft system 402 promptly identifies and terminates the execution.

The data storage monitoring system 504 is designed to track and manage the storage of data files within the aircraft's onboard systems. The data storage monitoring system 504 continuously monitors the storage size, file integrity, and any modifications to stored data to detect unauthorized changes or potential security risks. The data storage monitoring system 504 ensures that storage expansion remains within predefined limits and that any abrupt increase in file size is investigated.

The data exchange monitoring system 506 is responsible for overseeing all communications between the aircraft 404 and the ground station 406 to ensure secure and authorized data transfers. The data exchange monitoring system 506 monitors parameters such as the source and destination of data packets, the frequency and volume of data exchanges, and the timing of communications. It detects anomalies by identifying unexpected increases in data transmission, unusual data access requests, or communications originating from unknown sources. For example, if an unauthorized external entity attempts to send or retrieve data from the aircraft, the system flags the activity and issues an alert. Additionally, it implements encryption and authentication protocols to ensure that only authorized entities can participate in data exchanges, thus preventing data breaches, spoofing attacks, and unauthorized remote control attempts.

The process execution monitoring system 508 tracks the execution of software processes within the aircraft's onboard systems, ensuring that only authorized and planned processes are running. The process execution monitoring system 508 verifies all executing processes against a predefined schedule and list of authorized applications to detect any unauthorized or unplanned executions. If an unexpected process is initiated such as a malicious script, a rogue software installation, or an unauthorized system update the process execution monitoring system 508 immediately identifies it as a security risk. The process execution monitoring system 508 may terminate unauthorized processes, quarantine affected components, or trigger security alerts to notify the aircraft crew and ground station operators. By enforcing strict control over process execution, the process execution monitoring system 508 may prevent cyberattacks that rely on executing malicious code, such as ransomware, trojans, or rootkits.

By integrating these three monitoring systems form a multi-layered cybersecurity defense within the CMS 502. The data exchange monitoring system 506 ensures secure communications, the data storage monitoring system 504 safeguards onboard data, and the process execution monitoring system 508 prevents unauthorized software actions. These systems operate in real-time, sharing detected threats with both the aircraft crew and the ground station 406, enabling immediate responses to cyber incidents. If any of these systems detect suspicious activity, the CMS 502 can initiate mitigation strategies, such as blocking the unauthorized data exchanges, isolating compromised storage files, or aborting unauthorized processes.

In an embodiment, the avionic cabinet 500 is deployed with multiple applications hosted on multiple processors of a cyber security system and operates independently from each other. In an embodiment, the cyber security systems are the cybersecurity monitoring system 502 deployed as independent software modules, each hosted in separate modules to ensure isolation and security.

The cybersecurity monitoring system 502 is designed with differing degrees of rigor for different varying levels of the cybersecurity monitoring system 502. For example, some cybersecurity monitors may be developed to Level A standards to meet Safety Assurance Level 3 (SAL3) requirements, while others will adhere to Level C standards. This multi-layered approach to deployment ensures that the cybersecurity monitoring system 502 is robust, reliable, and capable of effectively protecting the aircraft system 402 against various threats.

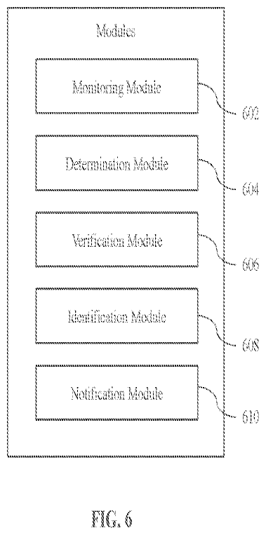

FIG. 6 illustrates a block diagram of modules for monitoring cybersecurity in the aircraft system 402, according to an embodiment of the present disclosure. According to an embodiment, the aircraft system 402 includes a monitoring module 602, a determination module 604, a verification module 606, an identification module 608, and a notification module 610 coupled with each other. In an embodiment, the monitoring module 602, the determination module 604, the verification module 606, the identification module 608, and the notification module 610 are uniquely designed hardware or software that are integrated within the aircraft system 402. According to some embodiment, the functions of the monitoring module 602, the determination module 604, the verification module 606, the identification module 608, and the notification module 610 can be performed by one or more processors. According to some embodiments, the monitoring module 602, the determination module 604, the verification module 606, the identification module 608, and the notification module 610 may be a part of an AI framework of the application to develop AI-powered solutions for specific tasks. An explanation will be made by referring to the modules depicted in FIG. 6. Furthermore, the labels depicted in the representative drawings are kept the same for similar components and operations throughout the disclosure for ease of understanding. The detailed functioning of each module will be explained in the following paragraphs.

The monitoring module 602 is configured to monitor continuously one or more parameters across multiple avionics components of the aircraft 404. The one or more parameters include a storage size of data files, data exchanges, and process execution, ensuring that the aircraft's systems remain secure from unauthorized access, data leaks, and cyber threats.

In an embodiment, the monitoring module 602 is designed to analyze the storage size of data files to detect potential anomalies. For example, if a sudden increase in storage size is observed beyond a predefined threshold, it may indicate unauthorized data accumulation or exfiltration attempts. Further, the monitoring module 602 continuously monitors the data exchanges between the aircraft 404 and external entities, such as ground stations, satellites, and other aircraft. Further, the monitoring module 602 is configured to monitor the process execution within the aircraft's avionics systems. The monitoring module 602 monitors authorized and unauthorized processes that are initiated and executed as per predefined schedules.

In an embodiment, the determination module 604 may be configured to perform an analysis of the one or more parameters to determine an increase in the storage size of data files, data access requests, the data exchanges, and the process executions. The determination module 604 determine the increase in the storage size of data file based on the abnormal increase in the data file beyond the threshold value, which may indicate unauthorized data accumulation, malware injection, or hidden data exfiltration attempts. For instance, if flight management system (FMS) logs suddenly expand in size the determination module 604 may determine the data file is beyond the threshold value.

Simultaneously, the determination module 604 may determine the data access requests from an unrecognized source, such as the ground station 406, a satellite and the other aircraft. Further, the determination module 604 may determine the data exchanges between the aircraft 404 and the ground station 406 or any other aircraft to determine unauthorized transactions, based on an analysis factor such as communication timing, data volume, and source authenticity. Furthermore, the determination module 604 may determine the process executions based on an unscheduled software update in between a mid-flight.

Upon determination of the storage size of data file, the verification module 606 may be configured to verify whether a content and a format of the one or more vulnerable data files are in a predefined format if the storage size of data file is beyond the threshold value. Upon determination of the data exchanges, the verification module 606 may be configured to verify the data access request from the unknown source is an authorized source by checking authentication credentials against the predefined security registry 520. The predefined security registry 520 stores information related to an authorized entity and permissions to access particular data by the authorized entity.

According to an embodiment, the identification module 608 may be configured to identify at least one vulnerability based on the analysis of the one or more parameters. The at least one vulnerability includes one or more of the unauthorized process execution, the unauthorized data access request, or an abrupt increase in the storage size of data files. The identification module 608 may be configured to categorize vulnerabilities within the aircraft system 402 by analyzing the one or more parameters such as the storage size fluctuations, the data access requests, and the process executions. After the determination module 604 determines anomalies in the one or more parameters, the identification module 608 may assess whether they constitute a security threat. If the threat is there, the notification module 610 may notify the pilot and the crew.

For example, if a data file experiences a sudden and unexplained increase in storage size, the identification module 608 classifies it as a potential data leak, unauthorized data accumulation, or malware infiltration. Similarly, when an unauthorized data access request is detected, such as an unregistered ground station attempting to retrieve sensitive avionics data, the identification module 608 flags it as a potential cyber intrusion. Further, if an unplanned process execution occurs, such as an unscheduled software update or an unrecognized application launch within the avionics system, the identification module 608 identifies it as a possible security breach. The identification module 608 enables early threat detection, categorizes the severity of each vulnerability, and triggers appropriate cybersecurity responses to protect critical aircraft systems from cyber threats and unauthorized activities.

The identification module 608 identifies vulnerabilities such as the unauthorized data access request, the abnormal increase in the storage size, or the unplanned process execution. Accordingly, based on the identification, the notification module 610 may be configured to notify an alert indicating the vulnerability detected within the aircraft system 402 to the pilot and the crew. This alert is transmitted through the aircraft's user interface (UI), ensuring real-time visibility for the crew. For example, if a sudden surge in data storage size is identified, the system notifies the crew about potential data leaks or malware attempting to infiltrate the aircraft system 402. Similarly, if the unauthorized ground station attempts to access avionics data, the module issues an immediate security alert, prompting the crew to verify the request. Further, if the unplanned process execution is detected, such as the unscheduled software update or an unfamiliar background process running in the avionics cabinet, the notification module 610 provides the alert, helping the crew take preventive actions.

In an exemplary embodiment, the ground station 406 may be integrated with the cybersecurity monitoring system 502 to oversee aircraft operations and ensure secure data exchanges between the aircraft 404 and the ground station 406. The ground station 406 works in tandem with the aircraft's onboard system, incorporating multiple monitoring module 602, determination module 604, verification module 606, identification module 608, and notification module 610 to detect and mitigate cyber threats in real-time. By deploying cybersecurity mechanisms at both ends, the system enhances aviation security by providing real-time monitoring, proactive threat detection, and rapid response capabilities.

The monitoring module 602 at the ground station continuously tracks one or more parameters associated with the aircraft's operational data, including storage size, data exchanges, and process executions. The monitoring module 602 may collect telemetry data transmitted from the aircraft 404, ensuring that any suspicious activities, such as unauthorized data accumulation or irregular aircraft system behavior, are promptly identified. For example, if the storage size of critical logs or sensor data suddenly increases beyond expected thresholds, the ground station's monitoring module 602 flags this anomaly and transmits the information to the determination module 604 for further analysis. The monitoring module 602 also monitors network traffic between the aircraft and external communication points to detect unauthorized access attempts or data breaches.

The determination module 604 at the ground station 406 processes incoming data from the aircraft 404 and assesses detected anomalies to determine whether they pose a security threat. The determination module 604 specifically evaluates conditions such as unexpected increases in data storage beyond a predefined threshold, data access requests from unknown sources that may indicate unauthorized attempts to retrieve sensitive aircraft information, unauthorized data exchanges with unverified entities suggesting a potential cyber intrusion, and unplanned process executions that may indicate the presence of malicious software or an unauthorized system override. For example, if an aircraft system attempts to communicate with an unverified external server, or a sudden surge in network activity is detected, the determination module 604 cross-checks these activities against predefined security registry 520. If the behavior is deemed suspicious, such as an external data source attempting to transmit unauthorized flight control commands, the determination module 604 detects the threat and escalates it for further process.

Once an anomaly is determined, the verification module 606 may be configured to verify whether a content and a format of the one or more vulnerable data files are in a predefined format if the storage size of data file is beyond the threshold value. Upon determination of the data exchanges, the verification module 606 may be configured to verify the data access request from the unknown source is an authorized source by checking authentication credentials against the predefined security registry 520.

Then, on verification, the identification module 608 identifies nature and severity of the security risk. It classifies the vulnerability based on one or more of the following factors the unauthorized process execution, which may indicate malware injection or system exploitation, an abrupt increase in storage size, possibly due to unauthorized data logging or an attempt to conceal malicious activity, and the unauthorized data access requests, which could signify an external hacking attempt or compromised credentials. If the aircraft is exhibiting signs of a potential cyber intrusion, such as an abnormal software execution within the avionics system or a discrepancy in data logs compared to expected operational behavior, the identification module 608 correlates this data with historical cybersecurity threats and determines whether it constitutes a critical vulnerability. The identification module 608 utilizes advanced anomaly detection algorithms and machine learning models to differentiate between normal operational variations and actual security threats. For example, if an attacker attempts to inject unauthorized commands into the aircraft's flight management system (FMS), the identification module 608 compares the incoming commands with the expected operational sequence. If a mismatch is detected, the identification module 608 classifies the event as a security breach, triggering an immediate security response.

Upon identifying the security risk, the notification module 610 at the ground station generates an alert notification for both the aircraft crew and ground operators. The notification provides detailed information regarding the nature of the identified vulnerability, the potential impact on flight operations, and recommended mitigation steps. For example, if an unauthorized data exchange is detected between the aircraft and an unknown entity, the notification module 610 alerts both the flight crew and the ground-based cybersecurity team. The notification prompts them to initiate defensive countermeasures, such as blocking the communication link to prevent further unauthorized data access, switching to a secure backup system to ensure continued safe flight operations, and isolating affected avionics components to prevent potential malware spread. Further, the notification module 610 logs all security incidents for post-event analysis, enabling cybersecurity teams to refine detection algorithms and strengthen defense mechanisms against future threats.

This exemplary embodiment ensures that the cybersecurity monitoring system operates seamlessly across both the aircraft and the ground station, providing real-time situational awareness, proactive threat detection, and rapid incident response. The integration of monitoring, determination, verification, identification, and notification modules at both ends creates a multi-layered security framework, protecting aviation networks from cyber threats.

For example, during a flight, if the ground station detects unusual activity, such as an external entity attempting to inject malicious data into the aircraft's avionics systems, the monitoring module 602 flags the anomaly. The determination module 604 assesses whether the activity is a false alarm or a genuine security threat and the verification module 606 verifies the activity. If confirmed, the identification module 608 categorizes the threat, and the notification module 610 ensures that alerts are dispatched to all relevant stakeholders. This real-time coordination between the ground station and the aircraft enables swift threat containment, risk mitigation, and system recovery, ensuring the safety of both passengers and crew.

By deploying multi-layered security mechanisms at both the aircraft 404 and the ground station 406, the system enhances aviation cybersecurity, safeguarding critical flight operations, data integrity, and communication security between airborne and ground-based infrastructures. The continuous monitoring and rapid response capabilities provided by this framework significantly reduce the risk of cyberattacks, ensuring safer and more resilient aviation networks. The forthcoming paragraphs will provide a detailed operation flow of the aircraft system 402 with respect to the category it belongs by referring through FIGS. 4 and 5.

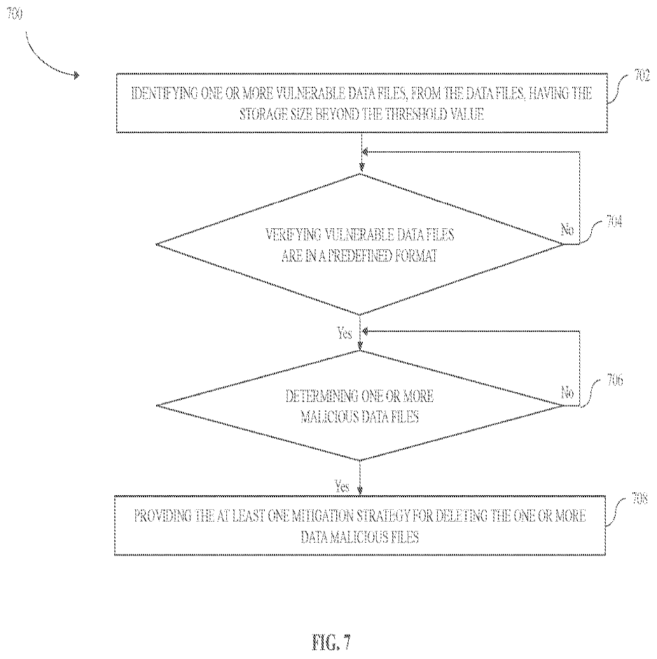

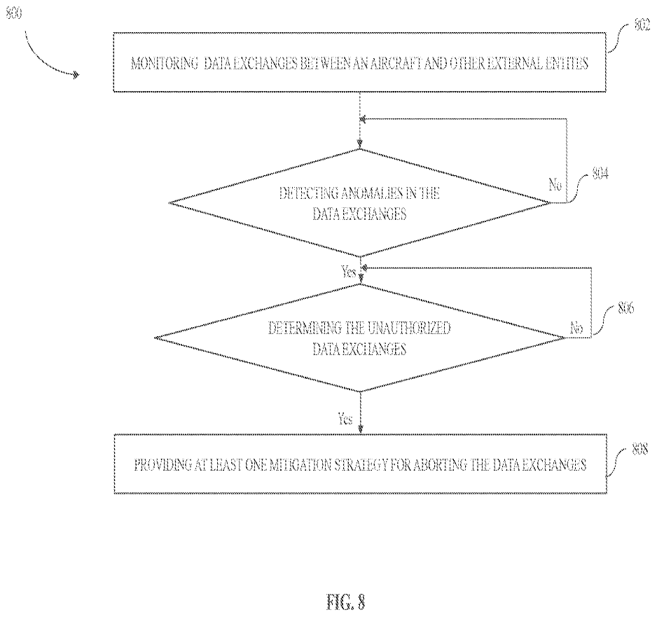

FIG. 7 illustrates a flow chart for a method 700 for the unauthorized data storage in the aircraft system 402, according to an embodiment of the present disclosure. At step 702, the identification module 608 may be configured to identify one or more vulnerable data files, from the data files. The data files having the storage size beyond the threshold value are the vulnerable data files. In an embodiment, the threshold value of the storage size is dynamically adjusted based on operational conditions and logs of the aircraft system 402.

At step 704, the verification module 606 may be configured to verify whether a content and a format of the one or more vulnerable data files are in a predefined format. In an embodiment, the content and the format of the data files include scanning with respect to the predefined format for at least one of file metadata, file structure, unauthorized data formats, unusual encryption techniques, metadata inconsistencies that indicate hidden data accumulation. In an embodiment, if the vulnerable data files are in the predefined format, the identification module 608 may be configured to again identify the one or more vulnerable data files. If the content and the format of the vulnerable data file is not verified then the aircraft system 402 may process to next step at 706 for determination of the unauthorized data storage in the vulnerable data files.

At step 706, the determination module 604 may be configured to determine one or more malicious data files among the one or more vulnerable data files based on the verification. The content and the format of the vulnerable data files are deviating from the predefined format. The deviation of the content and the format from the predefined format of the vulnerable data file shows the unauthorized data storage in the vulnerable data files.

At step 708, the determination module 604 may be configured to determine the unauthorized data storage then configured to provide at least one mitigation strategy for deleting the one or more data malicious files from the aircraft system 402. The notification module 610 may be configured to notify the pilot and the crew via an alert on a display screen of the aircraft 404. The pilot and the crew perform the mitigation strategy to delete the malicious data files from the aircraft system 402 upon receiving the alert.

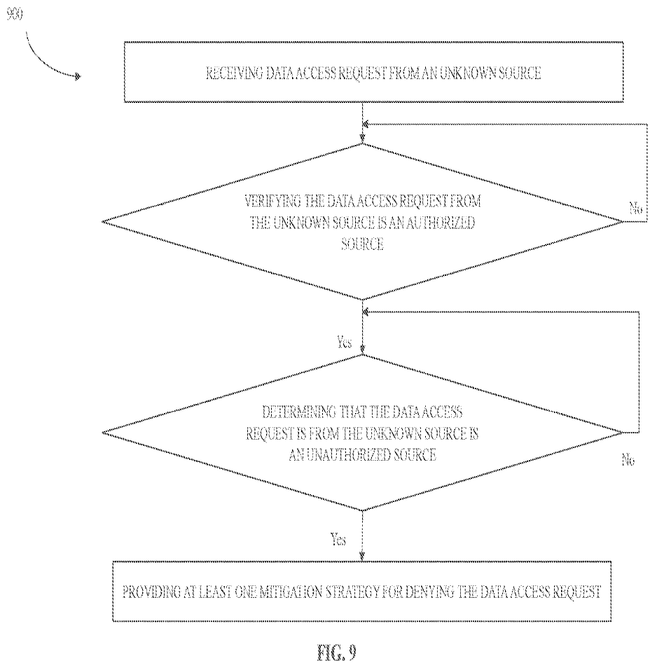

FIG. 8 illustrates a flow chart for a method 800 for the unauthorized data exchange in the aircraft system 402, according to an embodiment of the present disclosure. At step 802, the monitoring module 602 may be configured to monitor the data exchanges between the aircraft 404 and other external entities to detect anomalies in the data exchange. The other external entities may include the ground station 406, the satellite, and other aircraft.

At step 804, the determination module 604 may be configured to detect the anomalies in the data exchanges based on various parameters. The various parameters to detect the anomalies in the data exchange may include an unusual time at which the data exchanges occurred, a high frequency of the data exchanges, a high volume of a data transmission with the unknown source. In an embodiment, if the anomalies are not detected in the data exchange, the monitoring module 602 may be configured to again monitor the data exchange and if detected, the determination module 604 may be further configured to determine the unauthorized data exchange.

At step 806, the determination module 604 may be configured to determine the unauthorized data exchanges with the unknown source based on the anomalies in the data exchanges by continuously monitoring and analyzing data flow patterns within the aircraft system 402 and its communication network. The determination of the unauthorized data exchanges involves tracking data transmissions between the aircraft 404 and the other external entities, for identifying any irregularities that deviate from established communication protocols.

The aircraft system 402 first establishes a baseline of normal data exchange behavior by analyzing historical data transfer patterns, authorized network endpoints, expected data sizes, and transmission frequencies. Once this baseline is defined, any deviation from these patterns is flagged as a potential anomaly. In an embodiment, the anomalies are not determined in the data exchange between the aircraft 404 and the other external entities, the aircraft system 402 may again detect the anomalies in the data exchange.

At step 808, the determination module 604 may be further configured to determine the anomalies in the data exchange then configured to provide at least one mitigation strategy for aborting the data exchanges with the unknown source upon detecting the anomalies in the data exchanges. the notification module 610 may be configured to display the detected threat on the display screen of the aircraft 404 to notify the pilot and the crew to perform the recommended mitigation strategy.

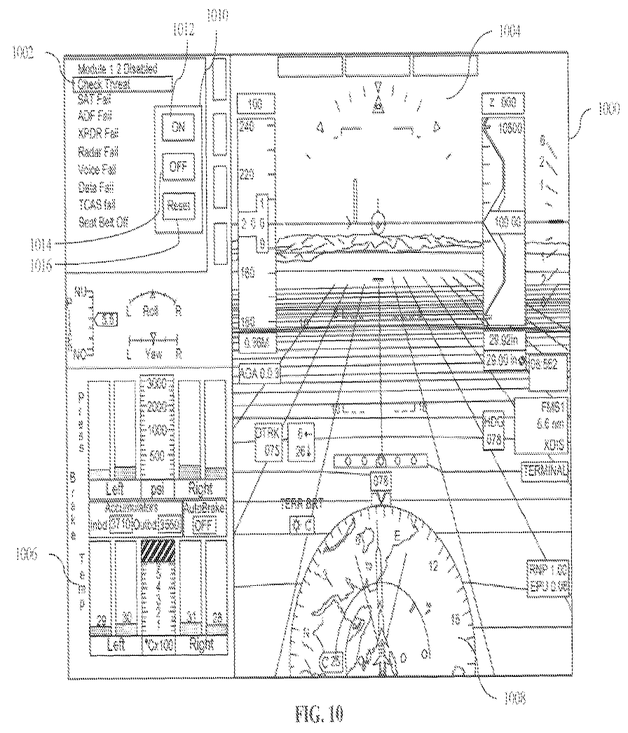

FIG. 9 illustrates a flow chart for a method 900 for the unauthorized data access request in the aircraft system 402, according to an embodiment of the present disclosure.

At step 902, the aircraft system 402 may receive data access request from an unknown source to access the aircraft data. In an embodiment, the data access request may be received from the ground station 406, the satellite, and the other aircraft to access the different data of the aircraft 404.

Upon receiving the data access request, at step 904, the verification module 606 may be configured to verify the data access request from the unknown source is an authorized source or not. The verification of the data access request involves, checking authentication credentials of the requesting source against the predefined security registry 520, which serves as the centralized database storing information related to authorized entities and their respective access permissions.

In an embodiment, when the data access request is received, the verification module 606 may be configured to extract relevant authentication credentials from the data access request, such as digital certificates, cryptographic keys, login tokens, or biometric signatures, depending on the security protocol in place. These credentials are then cross-checked against the predefined security registry 520, which contains a comprehensive list of authorized entities, including aircraft control centers, maintenance personnel, onboard crew, and trusted third-party service providers. Each authorized entity in the predefined security registry 520 is assigned specific access permissions, defining the types of data they are allowed to request and the operations they can perform on that data, such as read, write, modify, or delete. In an embodiment, if the data access request is verified, the aircraft system 402 may again verify the next request, and if not verified then aircraft system 402 may determine the unauthorized data access request at step 906.

At step 906, the determination module 604 may be configured to determine the data access request is from the unknown source is an unauthorized source based on the verification of the data access request. The determination module 604 may further provide at least one mitigation strategy for denying the data access request from the unauthorized source at step 908. The notification module 610 may be configured to display the determined data access request on the display screen of the aircraft 404 to notify the pilot and the crew to perform the recommended mitigation strategy.

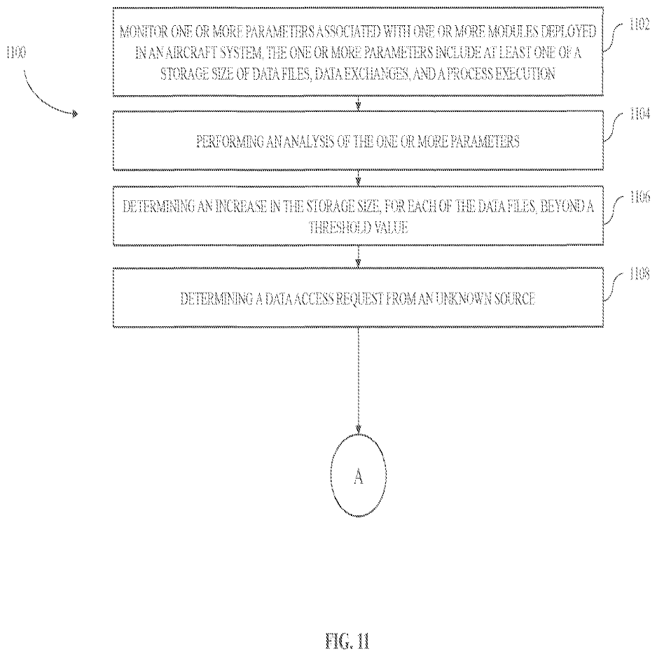

FIG. 10 illustrates an exemplary user interface (UI) for notifying the alert to the pilot or the crew, according to an embodiment of the present disclosure. According to an embodiment, FIG. 10 depicts an exemplary UI 1000, which represents the Primary Flight Display (PFD) of the aircraft 404, which integrates avionics, flight controls, and cybersecurity monitoring systems to provide the pilot and the crew with information related to the aircraft's operational status. The UI 1000 serves as the central hub for pilots to assess flight parameters, system health, and potential security threats in real-time.

The UI 1000 may be displayed on the display screen of the aircraft 404. The UI 1000 is displayed with a threat 1002 corresponds to a warning of Check Threat. This indicates that the aircraft system 402 may detected the threat in a Modular Avionics Unit 1 (MAU1), which is a computing system responsible for processing flight data and managing onboard avionics. The aircraft system 402 may continuously scan parameters such as the data storage of data file, the data exchanges, and the process executions to identify suspicious activities. The aircraft system 402 further analyzes these parameters and detects irregularities such as the abrupt increase in the storage size, the unauthorized data access requests, the unplanned process executions, and the unauthorized data exchanges with the unknown sources. In this case, the detection of the threat 1002 in the MAU1 suggests that the system has either been compromised due to a cyberattack or is experiencing an operational failure that requires immediate attention.

Further, the UI 1000 displays a list of system failures including ADF Fail (Automatic Direction Finder), TCAS Fail (Traffic Collision Avoidance System), WX Radar Fail (Weather Radar), and Iridium Data Fail (Satellite Communication System). These failures could be caused by cyber intrusions targeting communication and navigation systems, disrupting flight safety. The aircraft system 402 analyzes such failures and classifies them as the vulnerabilities based on their severity, whether they stem from the unauthorized process execution, the data storage, or external control attempts. If these failures are linked to a security breach, the aircraft system 402 immediately alerts the aircraft pilot and the crew, allowing them to take countermeasures, such as switching to backup systems or manually overriding compromised processes.

The UI 1000 displays a central section 1004 which presents flight parameters such as altitude, airspeed, heading, and artificial horizon, which are crucial for maintaining safe flight operations. Any tampering with these values could indicate an attempt to mislead the pilots or manipulate the aircraft's control system. The UI 1000 displays a brake accumulator pressure and a system health indicator, in lower section 1006 provides real-time feedback on the braking system, ensuring safe landing operations. The aircraft system 402 ensures that unauthorized modifications to these parameters, such as unexpected pressure loss or unplanned activation of braking mechanisms, are flagged as potential cyber threats.

Additionally, the navigation display (ND) 1008 provides information about the aircraft 404 flight path, terrain awareness, and proximity alerts. If the unauthorized data exchanges attempt to alter the navigation path, the aircraft system 402 detects the anomaly and alerts the crew before the aircraft 404 deviates from its intended course. The UI 1000 may include flight management system (FMS) data, which, if compromised, could lead to incorrect routing or altitude adjustments. The aircraft system 402 ensures that such vulnerabilities are promptly reported to the crew and the ground station for immediate action.

The UI 1000 may include an action box 1010 to perform mitigation strategies by the pilot and the crew of the aircraft 404. The action box 1010 may include an on-action button 1012, an off-action button 1014, and a reset action button 1016. The pilot may press the on-action button 1012 to ignore the alert displayed on the UI 1000. Similarly, the pilot may press the off-action button 1014 to prevent the alert displayed on the UI 1000 by performing the mitigation strategy. Further, the pilot may press the reset action button 1016 to reset the aircraft system 402 upon receiving the alert on the UI 1000.

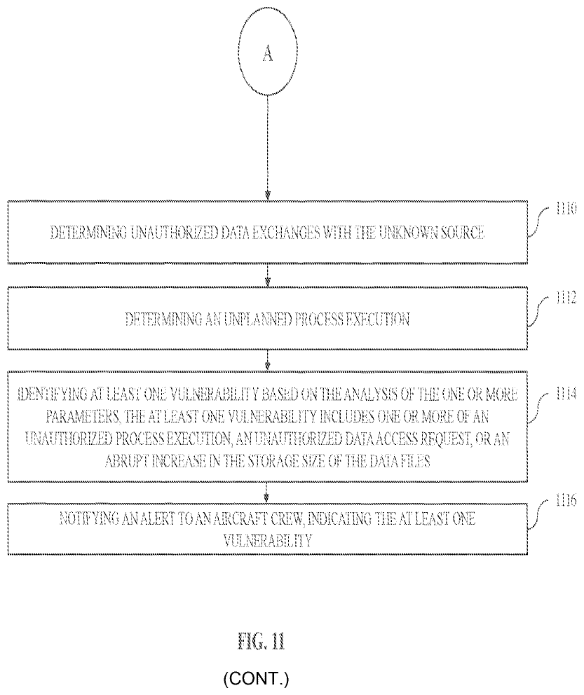

FIG. 11 illustrates a flow chart for a method 1100 for monitoring cybersecurity in the aircraft system, according to an embodiment of the present disclosure. The method 1100 is implemented in the aircraft system 402 of FIG. 4, and 5. Further, steps of the method 1100 are explained in detail through FIGS. 6 to 9, therefore for the sake of brevity, the detailed explanation has been omitted here.

In an embodiment, the aircraft system 402 monitoring cybersecurity in the aircraft. The monitoring is being performed by the monitoring module 602.

According to an embodiment, the method 1100, at step 1102 includes monitoring one or more parameters associated with one or more modules deployed in the aircraft system 402, where the one or more parameters include at least one of a storage size of data files, data exchanges, and a process execution. In an embodiment, the step 1102 are performed by the monitoring module 602.

Further, the method 1100, at step 1104 includes performing an analysis of the one or more parameters. In an embodiment, the step 1104 are performed by the determination module 604.

Further, the method 1100, at step 1106 includes determining an increase in the storage size, for each of the data files, beyond a threshold value. In an embodiment, the determination module 604 may be configured to determine the storage size of data file is beyond the threshold value, the data files are under category as one or more vulnerable data file. In an embodiment, the determination module 604 may be configured to determine one or more malicious data files among the one or more vulnerable data files based on a content and a format of the one or more vulnerable data files are deviating from a predefined format. In an embodiment, the content and the format of the data files include scanning with respect to the predefined format for at least one of file metadata, file structure, unauthorized data formats, unusual encryption techniques, metadata inconsistencies that indicate hidden data accumulation.

Further, the method 1100, at step 1108, includes determining a data access request from an unknown source. In an embodiment, the data access request from the unknown source is an authorized source by checking authentication credentials against a predefined security registry, where the predefined security registry stores information related to an authorized entity and permissions to access particular data by the authorized entity.

Further, the method 1100, at step 1110, includes determining unauthorized data exchanges with the unknown source based on an anomaly in the data exchanges. The anomalies in the data exchanges are detected based on an unusual time at which the data exchanges occurred, a high frequency of the data exchanges, and a high volume of a data transmission with the unknown source.

According to a further embodiment, the method 1100, at step 1112, includes determining an unplanned process execution. In an embodiment, the unplanned process execution as the unauthorized process execution based on a predefined schedule of the process execution. In an embodiment, the steps 1106, 1108, 1110, and 1112 are performed by the determination module 604.

Further, the method 1100, at step 1114, includes identifying at least one vulnerability based on the analysis of the one or more parameters, wherein the at least one vulnerability includes one or more of an unauthorized process execution, an unauthorized data access request, or an abrupt increase in the storage size of the data files. In an embodiment, the step 1114 is performed by the identification module 608.

Further, the method 1100, at step 1116, includes notifying an alert to an aircraft crew, indicating the at least one vulnerability. In an embodiment, the step 1116 is performed by the notification module 610.

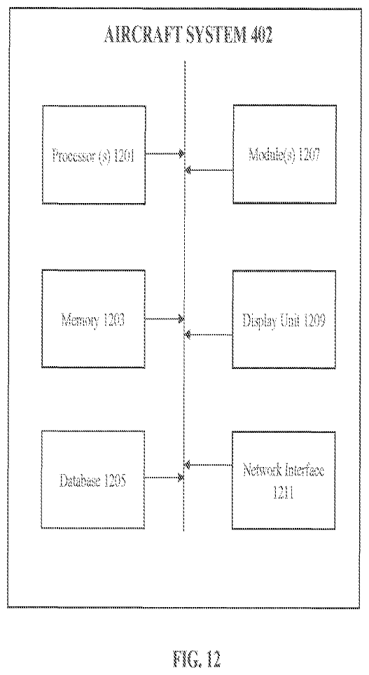

FIG. 12 illustrates a general block diagram of the aircraft system 402, according to an embodiment of the present disclosure. For an example, the processor(s) 1201 may be a single processing unit or a number of units, all of which could include multiple computing units. The processor(s) 1201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 1201 is configured to fetch and execute computer-readable instructions and data stored in the memory 1203.

The memory 1203 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 1207 may include a program, a subroutine, a portion of a program, a software component, or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 1207 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 907 when executed by the processor(s) 1201 may be configured to perform any of the described functionalities. According to an embodiment, the module 1207 includes the monitoring module 602, the determination module 604, the verification module 606, the identification module 608, and the notification module 610. In an alternate embodiment, the functions of the aforesaid modules may be performed by the processor(s) 1201.

As a further example, the database 1205 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processor(s) 1201, and the modules/engines/units 1207.

The modules/engines/units 1207 may be implemented with an AI module that may include a plurality of neural network layers. Examples of neural networks include, but are not limited to, a convolutional neural network (CNN), a deep neural network (DNN), a recurrent neural network (RNN), and a Restricted Boltzmann Machine (RBM). The learning technique is a method for training a predetermined target device using a plurality of learning data to cause, allow, or control the target device to make a determination or prediction. Examples of the learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 1209 includes a computer monitor, a touch screen, an output device capable of displaying the graphics, and the like. The display unit 1209 is configured to display visual output in desktops, laptops, and workstations. The display unit 1209 may come in different sizes, resolutions, and types (such as LCD, LED, or OLED).

As a further example, the network interface 1211 is configured to provide and establish communication with any electronic device via a public network, private network, or any wireless communication technology.

The disclosed technique, provides an improved method of identifying potential issues, and vulnerabilities at a granular level by deploying multiple scanning procedures at multiple stages of deployment of the software framework. This helps in securely deploying or executing an external software framework in end devices like edge devices, cloud-based systems, organizational devices, and the like.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and methods are set forth to provide a full understanding of the example embodiments. One of the ordinary skills in the art recognize the example embodiments that can be practiced without one or more specific details and/or with other methods.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

We claim:

1. A method, comprising:
monitoring one or more parameters associated with one or more modules deployed in an aircraft system, wherein the one or more parameters include at least one of a storage size of data files, data exchanges, and a process execution;
performing an analysis of the one or more parameters:
determining an increase in the storage size, for each of the data files, beyond a threshold value;
determining a data access request from an unknown source;
determining unauthorized data exchanges with the unknown source; and
determining an unplanned process execution;
identifying at least one vulnerability based on the analysis of the one or more parameters, wherein the at least one vulnerability includes one or more of an unauthorized process execution, an unauthorized data access request, or an abrupt increase in the storage size of the data files; and
notifying an alert to an aircraft crew, indicating the at least one vulnerability.

2. The method of claim 1, further comprising:
providing at least one mitigation strategy along with the alert, to address the at least one vulnerability.

3. The method of claim 2, further comprising:
identifying one or more vulnerable data files, from the data files, having the storage size beyond the threshold value;
verifying whether a content and a format of the one or more vulnerable data files are in a predefined format;
determining one or more malicious data files among the one or more vulnerable data files based on the verification that the content and the format of the one or more vulnerable data files are deviating from the predefined format; and
providing the at least one mitigation strategy for deleting the one or more data malicious files.

4. The method of claim 1, wherein the threshold value of the storage size is dynamically adjusted based on operational conditions and logs of the aircraft system.

5. The method of claim 3, wherein verifying the content and the format of the data files includes scanning with respect to the predefined format for at least one of file metadata, file structure, unauthorized data formats, unusual encryption techniques, metadata inconsistencies that indicate hidden data accumulation.

6. The method of claim 1, further comprising:
detecting anomalies in the data exchanges based on an unusual time at which the data exchanges occurred, a high frequency of the data exchanges, a high volume of a data transmission with the unknown source; and
determining the unauthorized data exchanges with the unknown source based on the anomalies in the data exchanges.

7. The method of claim 6, further comprising:
providing at least one mitigation strategy for aborting the data exchanges with the unknown source upon detecting the anomalies in the data exchanges.

8. The method of claim 1, further comprising:
verifying the data access request from the unknown source is an authorized source by checking authentication credentials against a predefined security registry, wherein the predefined security registry stores information related to an authorized entity and permissions to access particular data by the authorized entity; and
determining that the data access request is from the unknown source is an unauthorized source based on the verification.

9. The method as claimed in claim 8, further comprising:
providing at least one mitigation strategy for denying the data access request from the unauthorized source.

10. The method of claim 1, further comprising:
detecting the unplanned process execution as the unauthorized process execution based on a predefined schedule of the process execution; and
aborting the unplanned process execution based on the detection that the unplanned process execution is the unauthorized process execution.

11. An aircraft system, comprises:
one or more processors;
a memory; and
one or more programs stored in the memory, the one or more programs when executed by the one or more processors cause the one or more processors to:
monitor one or more parameters associated with one or more modules deployed in the aircraft system, wherein the one or more parameters include at least one of a storage size of data files, data exchanges, and a process execution;
perform an analysis of the one or more parameters to identify at least one vulnerability, the analysis includes:
determine an increase in the storage size, for each of the data files, beyond a threshold value;
determine a data access request from an unknown source;
determine unauthorized data exchanges with the unknown source; and
determine an unplanned process execution;
identify the at least one vulnerability based on the analysis of the one or more parameters, wherein the at least one vulnerability includes one or more of an unauthorized process execution, an unauthorized data access request, or an abrupt increase in the storage size of the data files; and
notify an alert to an aircraft crew, indicating the at least one vulnerability.

12. The aircraft system of claim 11, wherein the one or more processors are configured to:
provide at least one mitigation strategy along with the alert, to address the at least one vulnerability.

13. The aircraft system of claim 12, wherein the one or more processors are configured to:
identify one or more vulnerable data files, from the data files, having the storage size beyond the threshold value;
verify whether a content and a format of the one or more vulnerable data files are in a predefined format;
determine one or more malicious data files among the one or more vulnerable data files based on the verification that the content and the format of the one or more vulnerable data files are deviating from the predefined format; and
provide the at least one mitigation strategy for deleting the one or more data malicious files.

14. The aircraft system of claim 11, wherein the threshold value of the storage size is dynamically adjusted based on operational conditions and logs of the aircraft system.

15. The aircraft system of claim 13, wherein the one or more processors are configured to verify the content and the format of the data files includes scanning with respect to the predefined format for at least one of file metadata, file structure, unauthorized data formats, unusual encryption techniques, metadata inconsistencies that indicate hidden data accumulation.

16. The aircraft system of claim 11, wherein the one or more processors are configured to:
detect anomalies in the data exchanges based on an unusual time at which the data exchanges occurred, a high frequency of the data exchanges, a high volume of a data transmission with the unknown source; and
determine the unauthorized data exchanges with the unknown source based on the anomalies in the data exchanges.

17. The aircraft system of claim 16, wherein the one or more processors are configured to:
provide at least one mitigation strategy for aborting the data exchanges with the unknown source upon detecting the anomalies in the data exchanges.

18. The aircraft system of claim 11, wherein the one or more processors are configured to:
verify the data access request from the unknown source is an authorized source by checking authentication credentials against a predefined security registry, wherein the predefined security registry stores information related to an authorized entity and permissions to access particular data by the authorized entity:
determine that the data access request is from the unknown source is an unauthorized source based on the verification; and
provide at least one mitigation strategy for denying the data access request from the unauthorized source.

19. The aircraft system of claim 11, wherein the one or more processors are configured to:
detect the unplanned process execution as the unauthorized process execution based on a predefined schedule of the process execution; and
abort the unplanned process execution based on the detection that the unplanned process execution is the unauthorized process execution.

20. A non-transitory computer-readable storage medium storing program instructions for cybersecurity monitoring in an aircraft system, the program instructions, when executed, perform the steps of:
monitoring one or more parameters associated with one or more modules deployed in the aircraft system, wherein the one or more parameters include at least one of a storage size of data files, data exchanges, and a process execution;
performing an analysis of the one or more parameters to identify at least one vulnerability, the analysis includes:
determining an increase in the storage size, for each of the data files, beyond a threshold value;
determining a data access request from an unknown source;
determining unauthorized data exchanges with the unknown source; and
determining an unplanned process execution;
identifying the at least one vulnerability based on the analysis of the one or more parameters, wherein the at least one vulnerability includes one or more of an unauthorized process execution, an unauthorized data access request, or an abrupt increase in the storage size of the data files; and
notifying an alert to an aircraft crew, indicating the at least one vulnerability.
